(19) United States
(12) Patent Application Publication
(10) Pub. No.: US 2022/0332322 A1
(43) Pub. Date: Oct. 20, 2022

(54) APPARATUS AND METHOD FOR CONTROLLING POWER TRAIN OF VEHICLE

(71) Applicants: Hyundai Motor Company, Seoul (KR); Kia Corporation, Seoul (KR)

(72) Inventor: Jaesik YANG, Seoul (KR)

(73) Assignees: Hyundai Motor Company, Seoul (KR); Kia Corporation, Seoul (KR)

(21) Appl. No.: 17/461,519

(22) Filed: Aug. 30, 2021

(30) Foreign Application Priority Data
Apr. 14, 2021 (KR) 10-2021-0048538

(51) Int. Cl. B60W 30/18; B60W 10/06; B60W 10/10; B60W 10/08; B60W 20/10; B60K 6/26

(52) U.S. Cl. CPC B60W 30/18163; B60W 10/06; B60W 10/10; B60W 10/08; B60W 20/10; B60K 6/26; B60W 2540/18; B60W 2540/10; B60W 2554/804; B60W 2554/802; B60W 2520/10; B60W 2540/20; B60W 2510/0628; B60W 2510/1005; B60W 2510/083; B60W 2510/0657; B60Y 2200/92; B60Y 2300/18166

(57) ABSTRACT

An apparatus and method for controlling a power train of a vehicle may include an external information detection device detecting information on an external environment of the vehicle; an internal information detection device detecting information on a driving state of the vehicle; and a control device detecting occurrence of an overtaking situation of the vehicle according to the information on the external environment and the driving state, and controlling the power train of the vehicle based on a rotation angle of a steering wheel of the vehicle so that a response speed to a manipulation of an accelerator pedal in the vehicle speeds up when the occurrence of the overtaking situation of the vehicle is detected.

### CROSS-REFERENCE TO RELATED APPLICATION

The present application claims priority to Korean Patent Application No. 10-2021-0048538 filed on Apr. 14, 2021, the entire contents of which is incorporated herein for all purposes by this reference.

### BACKGROUND OF THE INVENTION

### Field of the Invention

The present invention relates to an apparatus and method for controlling a power train of a vehicle. More particularly, the present invention relates to an apparatus and method for controlling a power train in an overtaking situation of a vehicle.

### Description of Related Art

Control of a power train (an engine, a transmission, and a motor) for acceleration/deceleration of a vehicle is typically performed based on a manipulation currently performed in real time, such as a manipulation of an accelerator pedal, a brake pedal, a shift lever, or the like, by a driver.

Therefore, a predetermined time delay occurs until the driver's will to accelerate/decelerate the vehicle leads to actual acceleration/deceleration of the vehicle, which causes dissatisfaction of drivability. Particularly, in a situation in which instantaneous acceleration of the vehicle is required, such as an overtaking situation, an influence of such a time delay on a driver's feeling of acceleration further increases.

The information included in this Background of the Invention section is only for enhancement of understanding of the background of the invention and may not be taken as an acknowledgement or any form of suggestion that this information forms the prior art already known to a person skilled in the art.

### BRIEF SUMMARY

Various aspects of the present invention are directed to providing an apparatus and a method for controlling a vehicle that minimizes a time until the driver's will to accelerate the vehicle leads to actual acceleration of the vehicle in an overtaking situation.

Various aspects of the present invention are directed to providing an apparatus of controlling a power train of a vehicle, including: an external information detection device configured to detect information on an external environment of the vehicle; an internal information detection device configured to detect information on a driving state of the vehicle; and a control device configured to detect occurrence of an overtaking situation of the vehicle according to the information on the external environment and the driving state, and control the power train of the vehicle based on a rotation angle of a steering wheel of the vehicle so that a response speed to a manipulation of an accelerator pedal in the vehicle speeds up when the occurrence of the overtaking situation of the vehicle is detected.

The information on the external environment may include at least one of lane recognition information, a relative speed of the vehicle to a front vehicle, or inter-vehicle distance information of the vehicle to the front vehicle, and the information on the driving state may include information on at least one of a vehicle speed of the vehicle, the rotation angle of the steering wheel, a state of at least a turn signal lamp of the vehicle, and a manipulating state of the accelerator pedal of the vehicle.

The control device may be configured to predict that the overtaking situation has occurred when the control device determines that the steering wheel is rotated by a predetermined angle or more than the predetermined angle while the vehicle speed is a predetermined value or more than the predetermined value and the vehicle is approaching the front vehicle.

The control device may be configured to predict that the overtaking situation has occurred when the control device determines that the steering wheel is rotated by a predetermined angle or more than the predetermined angle and the at least a turn signal lamp of the vehicle is in a turn-on state while the vehicle speed is a predetermined value or more than the predetermined value and the vehicle is approaching the front vehicle.

The control device may be configured to predict that the overtaking situation has occurred when the control device determines that the steering wheel is rotated by a predetermined angle or more than the predetermined angle and the vehicle is approaching a lane while the vehicle speed is a predetermined value or more than the predetermined value and the vehicle is approaching the front vehicle.

The control device may be configured to predict an end of the overtaking situation according to the information on the external environment and the driving state when a manipulation of the accelerator pedal at a predetermined level or more than the predetermined level is not generated for a predetermined time period or more than the predetermined time period after the overtaking situation has occurred, and control the power train to return to a state of the power train before the occurrence of the overtaking situation when the controller determines that the overtaking situation has ended.

The control device may be configured to predict that the overtaking situation has ended when a manipulation of the accelerator pedal at a predetermined level or more than the predetermined level is not generated for a predetermined time period or more than the predetermined time period after the overtaking situation has occurred and the rotation angle of the steering wheel is less than a predetermined value.

The control device may be configured to predict that the overtaking situation has ended when the rotation angle of the steering wheel is less than a predetermined value and the at least a turn signal lamp of the vehicle is in a turn-off state while a manipulation of the accelerator pedal at a predetermined level or more than the predetermined level is not generated for a predetermined time period or more than the predetermined time period after the overtaking situation has occurred.

The control device may be configured to predict that the overtaking situation has ended in a case where the rotation angle of the steering wheel is less than a predetermined value and a lane change of the vehicle has occurred at least once after the overtaking situation has occurred while a manipulation of the accelerator pedal at a predetermined level or more than the predetermined level is not generated for a predetermined time period or more than the predetermined time period after the overtaking situation has occurred.

The control device may be configured to perform at least one of control of an amount of intake air of an engine in the vehicle, control of a pulley ratio of a transmission in the vehicle, and control of a torque of a motor in the vehicle based on the rotation angle of the steel wheel so that the response speed to the manipulation of the accelerator pedal speeds up when the control device determines that the overtaking situation has occurred.

The control device may be configured to perform control so that the amount of the intake air of the engine increases as the rotation angle of the steering wheel increases, when the control device determines that the overtaking situation has occurred.

The control device may be configured to decrease the pulley ratio as the rotation angle of the steering wheel increases, when the control device determines that the overtaking situation has occurred. The transmission may be a continuously variable transmission (CVT).

The control device may be configured to control the torque of the motor so that a regenerative amount of the motor decreases and an engine torque auxiliary amount of the motor increases as the rotation angle of the steering wheel increases, when the control device determines that the overtaking situation has occurred. The vehicle may be a mild hybrid electric vehicle (MHEV).

Various aspects of the present invention are directed to providing a method for controlling a power train of a vehicle, including: detecting information on an external environment of the vehicle and information on a driving state of the vehicle; determining occurrence of an overtaking situation of the vehicle according to the information on the external environment and the driving state; and controlling the power train of the vehicle based on a rotation angle of a steering wheel of the vehicle so that a response speed to a manipulation of an accelerator pedal in the vehicle speeds up when the occurrence of the overtaking situation of the vehicle is detected.

The information on the external environment may include at least one of lane recognition information, a relative speed of the vehicle to a front vehicle, or inter-vehicle distance information of the vehicle to the front vehicle, and the information on the driving state may include information on at least one of a vehicle speed of the vehicle, the rotation angle of the steering wheel, a state of at least a turn signal lamp of the vehicle, and a manipulating state of the accelerator pedal of the vehicle.

The detecting of the occurrence of the overtaking situation may include predicting that the overtaking situation has occurred when the control device determines that the steering wheel is rotated by a predetermined angle or more than the predetermined angle while the vehicle speed is a predetermined value or more than the predetermined value and the vehicle is approaching the front vehicle.

The detecting of the occurrence of the overtaking situation may include predicting that the overtaking situation has occurred when the control device determines that the steering wheel is rotated by a predetermined angle or more than the predetermined angle and the at least a turn signal lamp of the vehicle is in a turn-on state while the vehicle speed is a predetermined value or more than the predetermined value and the vehicle is approaching the front vehicle.

The detecting of the occurrence of the overtaking situation may include predicting that the overtaking situation has occurred when the control device determines that the steering wheel is rotated by a predetermined angle or more than the predetermined angle and the vehicle is approaching a lane while the vehicle speed is a predetermined value or more than the predetermined value and the vehicle is approaching the front vehicle.

The method for controlling a power train of a vehicle may further include: predicting an end of the overtaking situation according to the information on the external environment and the driving state when a manipulation of the accelerator pedal at a predetermined level or more than the predetermined level is not generated for a predetermined time period or more than the predetermined time period after the overtaking situation has occurred; and controlling the power train to return to a state of the power train before the occurrence of the overtaking situation when the end of the overtaking situation is predicted.

The predicting of the end of the overtaking situation may include determining that the overtaking situation has ended when a manipulation of the accelerator pedal at a predetermined level or more than the predetermined level is not generated for a predetermined time period or more than the predetermined time period after the overtaking situation has occurred and the rotation angle of the steering wheel is less than a predetermined value.

The predicting of the end of the overtaking situation may include determining that the overtaking situation has ended when the rotation angle of the steering wheel is less than a predetermined value and the at least a turn signal lamp of the vehicle is in a turn-off state while a manipulation of the accelerator pedal at a predetermined level or more than the predetermined level is not generated for a predetermined time period or more than the predetermined time period after the overtaking situation has occurred.

The predicting of the end of the overtaking situation may include determining that the overtaking situation has ended in a case where the rotation angle of the steering wheel is less than a predetermined value and a lane change of the vehicle has occurred at least once after the overtaking situation has occurred while a manipulation of the accelerator pedal at a predetermined level or more than the predetermined level is not generated for a predetermined time period or more than the predetermined time period after the overtaking situation has occurred.

The controlling of the power train may include performing at least one of control of an amount of intake air of an engine in the vehicle, control of a pulley ratio of a transmission in the vehicle, and control of a torque of a motor in the vehicle based on the rotation angle of the steel wheel so that the response speed to the manipulation of the accelerator pedal speeds up when the control device determines that the overtaking situation has occurred.

The performing of at least one of the control of the amount of intake air of the engine, the control of the pulley ratio of the transmission, and the control of the torque of the motor may include performing control so that the amount of the intake air of the engine increases as the rotation angle of the steering wheel increases, when the control device determines that the overtaking situation has occurred.

The performing of at least one of the control of the amount of intake air of the engine, the control of the pulley ratio of the transmission, and the control of the torque of the motor may include gradually decreasing the pulley ratio as the rotation angle of the steering wheel increases, when the control device determines that the overtaking situation has occurred.

The performing of at least one of the control of the amount of intake air of the engine, the control of the pulley ratio of the transmission, and the control of the torque of the motor may include controlling the torque of the motor so that a regenerative amount of the motor decreases and an engine torque auxiliary amount of the motor increases as the rotation angle of the steering wheel increases, when the control device determines that the overtaking situation has occurred.

According to various exemplary embodiments of the present invention, a driver's feeling of overtaking acceleration may be improved by minimizing a time until the driver's will to accelerate the vehicle leads to actual acceleration of the vehicle in an overtaking situation.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIG. 1 schematically illustrates an apparatus of controlling a power train of a vehicle according to an exemplary embodiment of the present invention.

FIG. 2 illustrates an example of an overtaking situation of the vehicle.

FIG. 3 illustrates an example in which the apparatus of controlling a power train according to an exemplary embodiment controls an amount of intake air of an engine according to a rotation angle of a steering wheel.

FIG. 4 illustrates an example in which the apparatus of controlling a power train according to an exemplary embodiment controls a pulley ratio of a transmission according to a rotation angle of a steering wheel.

FIG. 5 illustrates an example in which the apparatus of controlling a power train according to an exemplary embodiment controls a torque of a motor according to a rotation angle of a steering wheel.

FIG. 6 schematically illustrates a method for controlling a power train of a vehicle according to an exemplary embodiment of the present invention.

FIG. 7A schematically illustrates a method for predicting occurrence of an overtaking situation of the vehicle according to an exemplary embodiment of the present invention.

FIG. 7B schematically illustrates a method for predicting occurrence of an overtaking situation of the vehicle according to another exemplary embodiment of the present invention.

FIG. 7C schematically illustrates a method for predicting occurrence of an overtaking situation of the vehicle according to yet another exemplary embodiment of the present invention.

FIG. 8A schematically illustrates a method for predicting an end of an overtaking situation of the vehicle according to an exemplary embodiment of the present invention.

FIG. 8B schematically illustrates a method for predicting an end of an overtaking situation of the vehicle according to another exemplary embodiment of the present invention.

FIG. 8C schematically illustrates a method for predicting an end of an overtaking situation of the vehicle according to yet another exemplary embodiment of the present invention.

It may be understood that the appended drawings are not necessarily to scale, presenting a somewhat simplified representation of various features illustrative of the basic principles of the present invention. The specific design features of the present invention as included herein, including, for example, specific dimensions, orientations, locations, and shapes will be determined in part by the particularly intended application and use environment.

In the figures, reference numbers refer to the same or equivalent parts of the present invention throughout the several figures of the drawing.

### DETAILED DESCRIPTION

Reference will now be made in detail to various embodiments of the present invention(s), examples of which are illustrated in the accompanying drawings and described below. While the present invention(s) will be described in conjunction with exemplary embodiments of the present invention, it will be understood that the present description is not intended to limit the present invention(s) to those exemplary embodiments. On the other hand, the present invention(s) is/are intended to cover not only the exemplary embodiments of the present invention, but also various alternatives, modifications, equivalents and other embodiments, which may be included within the spirit and scope of the present invention as defined by the appended claims.

Hereinafter, various exemplary embodiments included in the exemplary embodiment will be described in detail with reference to the accompanying drawings, but the same or similar components will be denoted by the same or similar reference numerals, and an overlapping description therefore will be omitted.

Terms “module” and/or “unit” for components used in the following description are used only to easily make the specification. Therefore, these terms do not have meanings or roles that distinguish from each other in themselves. Furthermore, when it is determined that a detailed description for known technologies related to the exemplary embodiment in describing exemplary embodiments disclosed in the exemplary embodiment may unnecessarily obscure the gist of exemplary embodiments disclosed in the exemplary embodiment, the detailed description will be omitted. Furthermore, it should be understood that the accompanying drawings are provided only to allow exemplary embodiments disclosed in the exemplary embodiment to be easily understood, and the spirit disclosed in the exemplary embodiment of the present invention is not limited by the accompanying drawings, but includes all the modifications, equivalents, and substitutions included in the spirit and the scope of the present invention.

Terms including an ordinal number such as first and second may be used to describe various components, but these components are not limited by these terms. These terms are used only for distinguishing one component from another component.

It is to be understood that when one component is referred to as being “connected to” another component, it may be directly connected to another component or be connected to another component with the other component interposed therebetween. On the other hand, it is to be understood that when one component is referred to as being “directly connected to” another component, it may be connected to another component without the other component interposed therebetween.

It may be understood that terms “include” or “have” used in the present invention specify the presence of features, numerals, steps, operations, components, parts mentioned in the exemplary embodiment, or a combination thereof, but do not preclude the presence or addition of one or more other features, numerals, steps, operations, components, portions, or a combination thereof.

Furthermore, terms such as “˜ unit”, “˜er/or”, “module”, and “means” described in the specification refer to a unit that processes at least one function or operation, and may be implemented as hardware, software, or a combination of hardware or software.

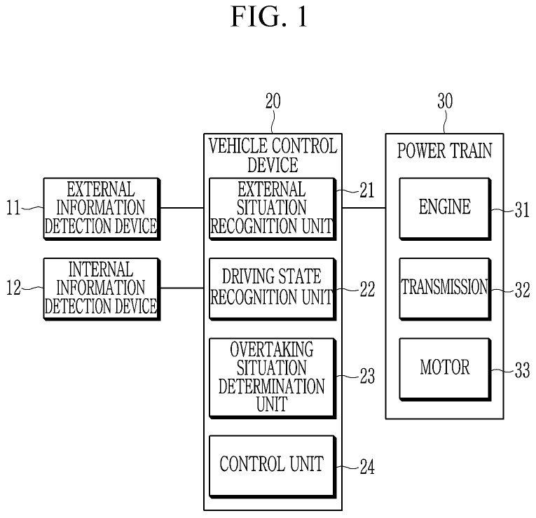

FIG. 1 schematically illustrates an apparatus of controlling a power train of a vehicle according to an exemplary embodiment of the present invention.

Referring to FIG. 1, the apparatus of controlling a power train according to various exemplary embodiments of the present invention may include an external information detection device 11, an internal information detection device 12, and a vehicle control device 20.

The external information detection device 11 detects information on an external situation of the vehicle. To the present end, the external information detection device 11 may include at least one sensor mounted in the vehicle. For example, the external information detection device 11 may include at least one of a camera, a radio detection and ranging (radar), a laser imaging detection and ranging (LADAR), and an ultrasonic sensor. Furthermore, for example, the external information detection device 11 may further include a lane recognition sensor, a blind spot detection (BSD) sensor, and the like. The camera may be used to detect a surrounding object (for example, another vehicle) that has approached to the vehicle by capturing an image of a surrounding environment of the vehicle. The radar sensor may be used to transmit an electromagnetic wave signal to the surroundings of the vehicle and detect information such as a distance to a surrounding object, a movement speed, and a direction based on a signal returning by reflection of the transmitted electromagnetic wave signal by the surrounding object (for example, another vehicle). The LIDAR may be used to transmit a laser signal to the surroundings of the vehicle and receive a signal returning by reflection of the transmitted laser signal by a surrounding object (for example, another vehicle) to detect information such as a distance to the surrounding object, a movement speed, and a direction, and may be used to extract three-dimensional (3D) spatial information around the vehicle to detect shape information of the surrounding object. The ultrasonic sensor may be used to transmit an ultrasonic signal to the surroundings of the vehicle and detect information such as a distance to the surrounding object, a movement speed, and a direction based on a signal returning by reflection of the transmitted ultrasonic signal by the surrounding object (for example, another vehicle). The lane recognition sensor, which is a sensor for recognizing a lane of a road on which the vehicle is traveling, may be used to detect a distance between the vehicle and the lane, a lane departure of the vehicle, and the like. The blind spot detection sensor may be used to detect a surrounding object (for example, another vehicle) positioned in a blind spot such as a rear side thereof. In addition to these sensors, various sensors for detecting information on the surrounding environment of the vehicle may be used.

The internal information detection device 12 detects information on a driving state such as a traveling state, an operating state, and a manipulating state of the vehicle. To the present end, the internal information detection device 12 may include at least one sensor mounted in the vehicle. For example, the internal information detecting unit 12 may include an acceleration sensor, a vehicle speed sensor, an accelerator pedal sensor (APS), a brake pedal sensor (BPS), a steering wheel sensor, and the like. The acceleration sensor and the vehicle speed sensor may be used to detect an acceleration and a traveling speed of the vehicle. The accelerator pedal sensor may be used to detect a manipulating state of an accelerator pedal of the vehicle. The brake pedal sensor may be used to detect a manipulating state of a brake pedal of the vehicle. The steering wheel sensor may be used to detect rotation angle information of a steering wheel. The internal information detection device 12 may detect an operating state (turn signal) of a turn signal lamp of the vehicle as internal information of the vehicle.

The vehicle control device 20 may predict an overtaking situation of the vehicle based on the information on the external situation of the vehicle and the information on the driving state of the vehicle, and control a power train 30 of the vehicle based on the predicted overtaking situation.

To the present end, the vehicle control device 20 may include an external situation recognition unit 21, a driving state recognition unit 22, an overtaking situation determination unit 23, and a control unit 24.

The external situation recognition unit 21 may identify the external situation of the vehicle based on the information detected through the external information detection device 11.

The driving state recognition unit 22 may identify the driving state of the vehicle based on the information detected through the internal information detection device 12.

The overtaking situation determination unit 23 may predict the overtaking situation of the vehicle based on the external situation of the vehicle identified through the external situation recognition unit 21 and the driving state of the vehicle identified through the driving state recognition unit 22, and control the power train 30 of the vehicle according to the predicted overtaking situation. That is, the overtaking situation determination unit 23 may predict the occurrence of the overtaking situation of the vehicle through at least one of a vehicle speed of the vehicle, a relative speed to a front vehicle or an inter-vehicle distance to the front vehicle, a rotation angle of the steering wheel, a manipulating state of the turn signal lamp, a manipulating state of the accelerator pedal, and lane recognition information, or a combination thereof.

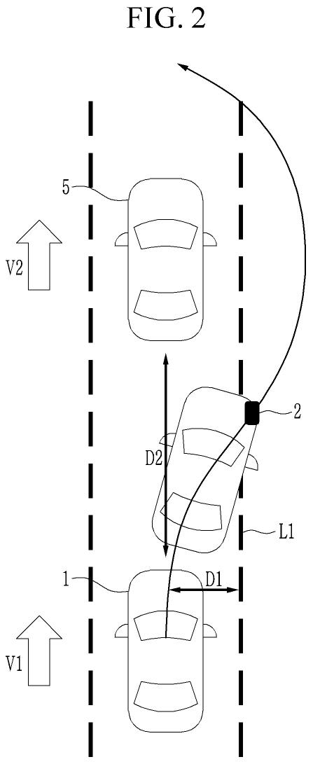

FIG. 2 schematically illustrates an example of a situation in which a vehicle attempts to overtake. Taking FIG. 2 as an example, the overtaking situation determination unit 23 may recognize a situation in which a vehicle 1 mounted with the overtaking situation determination unit 23 is overtaking when the vehicle 1 becomes gradually close to a lane L1 (a distance D1 between the vehicle 1 and the lane decreases) or a turn signal lamp 2 is turned on in a situation in which a vehicle speed V1 of the vehicle 1 is a predetermined value (for example, 20 km/h) or more and the vehicle 1 gradually approaches a front vehicle 5, that is, a situation in which a speed difference (V2−V1) between the vehicle 1 and the front vehicle 5 is negative or an inter-vehicle distance D2 between the vehicle 1 and the front vehicle 5 decreases.

Furthermore, for example, the overtaking situation determination unit 23 may recognize a situation in which the vehicle 1 mounted with the overtaking situation determination unit 23 is overtaking when the steering wheel of the vehicle is in a state in which it is rotated by a predetermined angle (for example, 20°) or more in a situation in which the vehicle speed V1 of the vehicle 1 is a predetermined value (for example, 20 km/h) or more and the vehicle 1 gradually approaches the front vehicle 5.

Furthermore, for example, the overtaking situation determination unit 23 may predict an end of the overtaking situation when a rotation angle of the steering wheel falls to be within a predetermined value, the vehicle crosses the lane, or all turn signal lamps are turned off in a state in which a manipulation of the accelerator pedal has not been generated for a predetermined time period (for example, 3 seconds) after the situation in which the vehicle is overtaking is recognized.

When the occurrence of the overtaking situation is detected by the overtaking situation determination unit 23, the control unit 24 may perform the control of the power train in advance according to the rotation angle of the steering wheel so that rapider acceleration than a normal traveling state is possible at the time of manipulating the accelerator pedal. That is, the control unit 24 may make rapid acceleration possible at the time of manipulating the accelerator pedal later by controlling at least one of an engine 31, a transmission 32, and a motor 33 in advance based on the rotation angle of the steering wheel so that a response speed to the manipulation of the accelerator pedal speeds up, based on the angle of the steering wheel.

When the situation in which the vehicle is overtaking is recognized by the overtaking situation determination unit 23, the control unit 24 may secure a reserve torque by increasing an amount of air supplied to the engine 31 (an amount of air introduced into a cylinder of the engine 31 so that rapid acceleration is possible at the time of manipulating the accelerator pedal later. That is, the control unit 24 may increase the amount of air supplied to the engine 31 by controlling a throttle to be opened at a rotation angle increased as compared with a throttle angle set to correspond to a current manipulating state of the accelerator pedal through throttle control of the engine 31. In a case where the vehicle is provided with a turbo charger, the control unit 24 may close a waste-gate to increase the amount of the intake air of the engine 31.

In the normal traveling state, the air amount in the engine 31 may be increased by further pressing down the accelerator pedal or by performing compression control of an intake system of the turbocharger. However, the amount of the intake air of the engine 31 is slowly increased due to a mass flow of air. Therefore, a predetermined time delay occurs from a point in time when the control for increasing the amount of the intake air of the engine 31 is started to a point in time when the amount of the intake air of the engine 31 is increased to a desired amount such that a slow response speed appears.

However, in a case where the amount of the intake air of the engine 31 is increased in advance to be sufficiently ensure in a state in which the overtaking situation is identified as described above, as soon as a driver manipulates the accelerator pedal for overtaking, a desired torque may be rapidly reached through adjustment of an ignition timing.

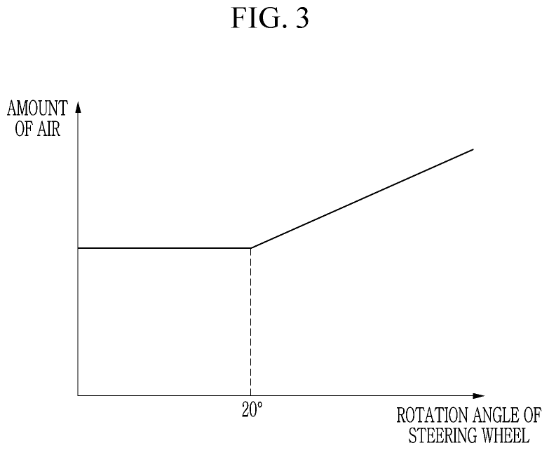

FIG. 3 illustrates an example in which the vehicle control device 20 controls the amount of the intake air of the engine 31 according to the rotation angle of the steering wheel in a state in which the situation in which the vehicle is overtaking is recognized. Taking FIG. 3 as an example, when the vehicle is overtaking (the rotation angle of the steering wheel is 20° or more), the control unit 24 may control the amount of the intake air of the engine 31 so that the secured amount of intake air of the engine 31 increases as the rotation angle of the steering wheel increases.

Referring to FIG. 1 again, in a case where the transmission 32 of the vehicle is a continuously variable transmission (CVT), the control unit 24 may improve a feeling of acceleration in an acceleration situation of the vehicle for overtaking by gradually decreasing a pulley ratio of the transmission 32 when the situation in which the vehicle is overtaking is recognized by the overtaking situation determination unit 23. Here, the pulley ratio refers to a diameter ratio between belts in contact with a driving pulley and a driven pulley of the CVT, and substantially corresponds to a gear ratio of the CVT.

The CVT may change only revolutions per minute (RPM) of the engine without a change in torque (without impact) by gradually changing the pulley ratio unlike a stepped transmission. Furthermore, a low pulley ratio in the CVT corresponds to the use of a lower gear in a stepped transmission, and means that the engine operates at a higher RPM at the same vehicle speed. Therefore, in a case where the pulley ratio is low, the RPM may be increased faster than a state in which the pulley ratio is high such that the acceleration of the vehicle may be rapidly performed.

Therefore, in a case where the pulley ratio of the transmission 32 is gradually decreased in the state in which the overtaking situation is identified as described above, when the driver manipulates the accelerator pedal for overtaking, the rapid acceleration is possible such that the feeling of acceleration may be improved.

Meanwhile, when it is determined by the overtaking situation determination unit 23 that the overtaking situation has ended, the control unit 24 may control the power train of the vehicle to gradually return to a control state before the overtaking occurs. For example, when it is determined that the overtaking situation has ended, the control unit 24 may control the throttle angle or the waste-gate of the engine 31 so that the amount of the intake air of the engine 31 gradually decreases to a state before the overtaking situation. Furthermore, for example, when it is determined that the overtaking situation has ended, the control unit 24 may control the pulley ratio of the transmission 32 so that the pulley ratio of the transmission 32 gradually increases to a state before the overtaking situation. Furthermore, for example, when it is determined that the overtaking situation has ended, the control unit 24 may gradually return a torque of the motor 33 to a state before the overtaking situation. That is, the control unit 24 may control the torque of the motor 33 so that a regenerative amount or a torque auxiliary amount of the motor 33 returns to a state before the overtaking situation.

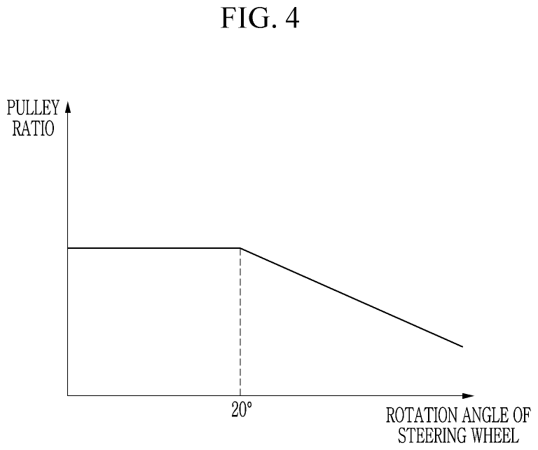

FIG. 4 illustrates an example in which the vehicle control device 20 controls the pulley ratio of the transmission 32 according to the rotation angle of the steering wheel in the state in which the situation in which the vehicle is overtaking is recognized. Taking FIG. 4 as an example, in the situation in which the vehicle is overtaking (the rotation angle of the steering wheel is 20° or more), the control unit 24 may control the transmission 32 so that the pulley ratio of the transmission 32 decreases as the rotation angle of the steering wheel increases.

Referring to FIG. 1 again, when the situation in which the vehicle is overtaking is recognized by the overtaking situation determination unit 23, the control unit 24 may improve a feeling of acceleration in an acceleration situation of the vehicle for overtaking by decreasing the regenerative amount of the motor 33 and increasing the torque auxiliary amount of the motor 33 used to assist in a torque of the engine 31.

In a case of a mild hybrid electric vehicle (MHEV), in a case where the regenerative amount of the motor 33 used to assist in the torque of the engine 31 is decreased, a torque acting in a negative (−) direction on the torque of the engine 31 may be decreased such that rapid acceleration may become possible. In addition to this, in a case where the auxiliary torque amount of the motor 33 assisting in a driving torque of the engine 31 is gradually increased, a torque acting on the driving torque of the engine 31 in a positive (+) direction increases, and acceleration of the vehicle may thus be more rapidly performed.

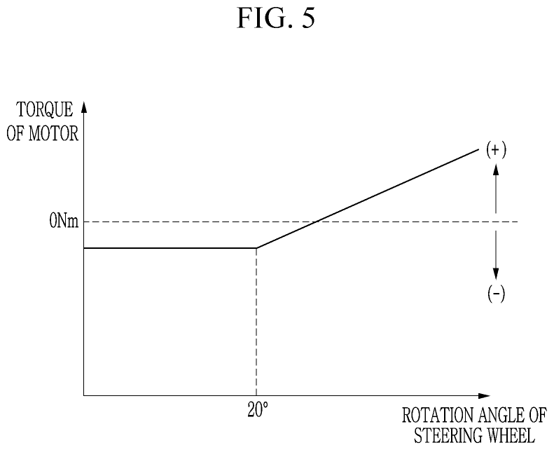

FIG. 5 illustrates an example in which the vehicle control device 20 controls the torque of the motor 33 according to the rotation angle of the steering wheel in the state in which the situation in which the vehicle is overtaking is recognized, and illustrates a torque of a motor acting relative to the driving torque of the engine 31. Taking FIG. 5 as an example, in the situation in which the vehicle is overtaking (the rotation angle of the steering wheel is 20° or more), the control unit 24 may control the torque of the motor 33 so that the regenerative amount (regenerative torque) of the motor 33 acting in a negative (−) direction with respect to the driving torque of the engine 31 gradually decreases and the torque auxiliary amount of the motor 33 acting in a positive (+) direction with respect to the driving torque of the engine 31 gradually increases as the rotation angle of the steering wheel increases.

The vehicle control device 20 described above includes at least one electronic control unit mounted in the vehicle, and the external situation recognition unit 21, the driving state recognition unit 22, the overtaking situation determination unit 23, and the control unit 24 may be implemented by at least one electronic control unit included in the vehicle control device 20. For example, the vehicle control device 20 may include at least one of a hybrid control unit (HCU), an engine control unit (ECU), a motor control unit (MCU), and a transmission control unit (TCU).

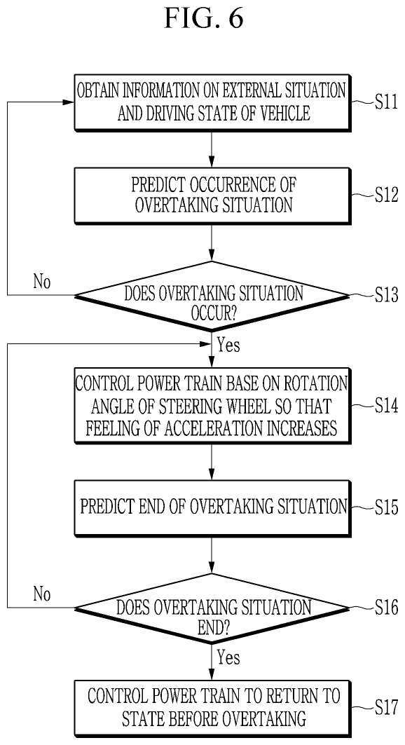

Hereinafter, a method for controlling a power train of the apparatus of controlling a power train described above will be described in detail with reference to FIGS. 6 to 8B. Methods to be described below may be performed by the vehicle control device 20 of the apparatus of controlling a power train described with reference to FIG. 1.

FIG. 6 schematically illustrates a method for controlling a power train of a vehicle according to an exemplary embodiment of the present invention.

Referring to FIG. 6, the vehicle control device 20 may obtain the information on the external situation of the vehicle through the external information detection device 11 and obtain the information on the driving state of the vehicle through the internal information detection device 12 (S11). Furthermore, the vehicle control device 20 may predict occurrence of the overtaking situation of the vehicle based on the obtained information on the external situation and the driving state of the vehicle (S12).

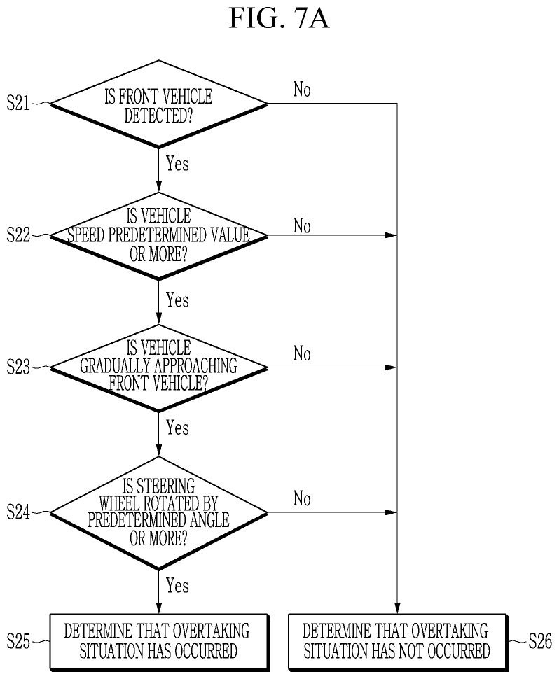

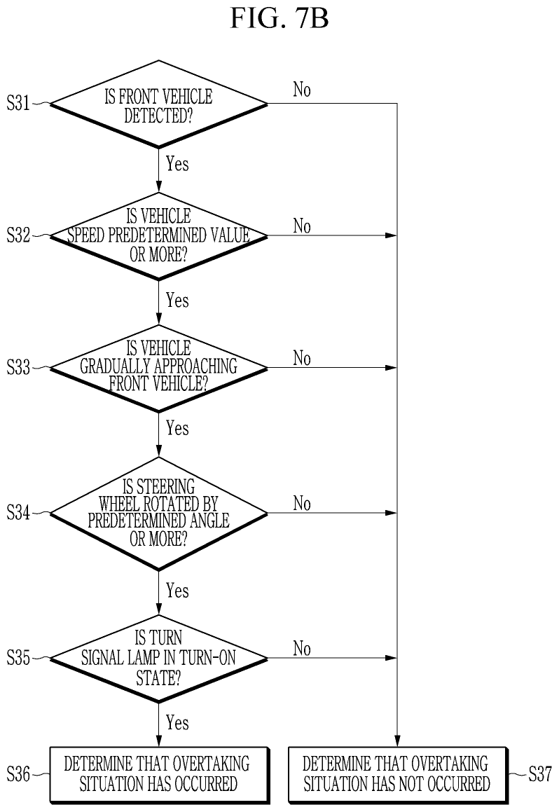

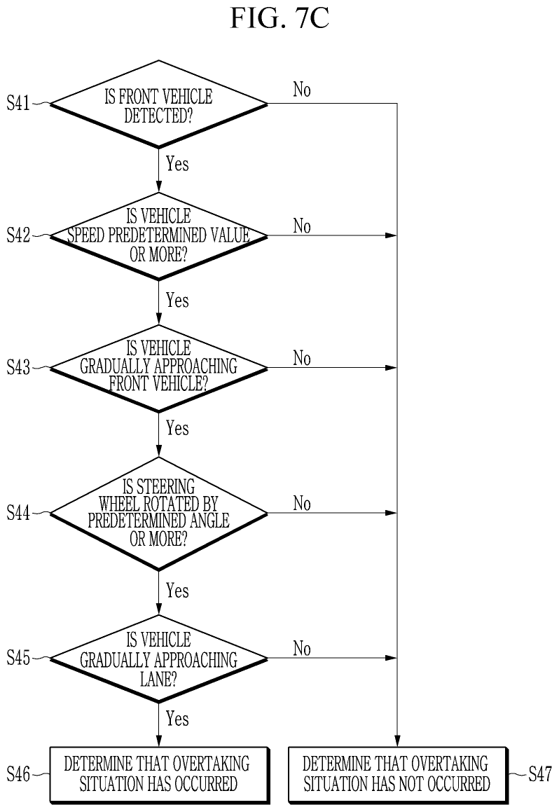

FIG. 7A, FIG. 7B, and FIG. 7C schematically illustrate different exemplary embodiments of a method for predicting occurrence of an overtaking situation of a vehicle.

FIG. 7A schematically illustrates a method for predicting occurrence of an overtaking situation of the vehicle according to an exemplary embodiment of the present invention.

Referring to FIG. 7A, the vehicle control device 20 may confirm whether or not the front vehicle traveling in front of the vehicle exists, based on the information on the external situation obtained in S11 (S21). Furthermore, the vehicle control device 20 may confirm whether or not the vehicle speed of the vehicle is a predetermined value or more than the predetermined value through S11 (S22).

When it is confirmed that the front vehicle exists and the current vehicle speed of the vehicle is the predetermined value or not through S21 and S22, the vehicle control device 20 may confirm whether or not the vehicle is gradually approaching the front vehicle (S23). Here, the vehicle control device 20 may determine that the vehicle is approaching the front vehicle when a relative speed of the vehicle to the front vehicle (a speed of the front vehicle—a current speed of the vehicle) is less than 0 or an inter-vehicle distance between the front vehicle and the vehicle gradually decreases.

When it is confirmed in S23 that the vehicle is gradually approaching to the front vehicle, the vehicle control device 20 may conform whether or not the steering wheel of the vehicle is rotated by a predetermined angle (for example, 20°) or more to determine the occurrence of the overtaking situation (S24). Furthermore, when it is detected through S24 that the steering wheel of the vehicle is rotated by the predetermined angle or more, the vehicle control device may determine that the overtaking situation has occurred (S25).

On the other hand, when the front vehicle does not exist, the vehicle speed of the vehicle is less than the predetermined value, the vehicle is not gradually approaching the front vehicle, or the rotation angle of the steering wheel is less than the predetermined value, the vehicle control device 20 may determine that the overtaking situation has not occurred (S26).

FIG. 7B schematically illustrates a method for predicting occurrence of an overtaking situation of the vehicle according to another exemplary embodiment of the present invention. The method for predicting occurrence of an overtaking situation of FIG. 7B may further include confirming a state of a turn signal lamp, as compared with the method for predicting occurrence of an overtaking situation of FIG. 7A.

Referring to FIG. 7B, when the front vehicle exists (S31), the vehicle speed of the vehicle is the predetermined value or more (S32), the vehicle is gradually approaching the front vehicle (S33), and the steering wheel is rotated by the predetermined angle or more (S34), the vehicle control device 20 may additionally confirm whether or not any one of the turn signal lamps is in a turn-on state in order to precisely determine the overtaking situation (S35). Furthermore, when any one of the turn signal lamps is in the turn-on state, the vehicle control device 20 may finally determine that the overtaking situation has occurred (S36).

On the other hand, when the front vehicle does not exist, the vehicle speed of the vehicle is less than the predetermined value, the vehicle is not gradually approaching the front vehicle, the rotation angle of the steering wheel is less than the predetermined value, or all of the turn signal lamps are in a turn-off state, the vehicle control device 20 may determine that the overtaking situation has not occurred (S37).

FIG. 7C schematically illustrates a method for predicting occurrence of an overtaking situation of the vehicle according to yet another exemplary embodiment of the present invention. The method for predicting occurrence of an overtaking situation of FIG. 7C may further include confirming whether or not the vehicle is gradually approaching a lane, as compared with the method for predicting occurrence of an overtaking situation of FIG. 7A.

Referring to FIG. 7C, when the front vehicle exists (S41), the vehicle speed of the vehicle is the predetermined value or more (S42), the vehicle is gradually approaching the front vehicle (S43), and the steering wheel is rotated by the predetermined angle or more (S44), the vehicle control device 20 may additionally confirm whether or not the vehicle is gradually approaching a left or right lane to precisely determine the overtaking situation (S45). Furthermore, when the vehicle is gradually approaching any one of the left and right lanes, the vehicle control device 20 may finally determine that the overtaking situation has occurred (S46).

On the other hand, when the front vehicle does not exist, the vehicle speed of the vehicle is less than the predetermined value, the vehicle is not gradually approaching the front vehicle, the rotation angle of the steering wheel is less than the predetermined value, or the vehicle is not gradually approaching the lane, the vehicle control device 20 may determine that the overtaking situation has not occurred (S47).

Referring to FIG. 6 again, when it is determined that the overtaking situation has occurred through the methods for predicting occurrence of an overtaking situation described above, the vehicle control device 20 may control the power train of the vehicle based on the rotation angle of the steering wheel so that the feeling of acceleration increases, that is, the response speed to the manipulation of the accelerator pedal speeds up (S14). That is, in a state in which it is determined that the overtaking situation has occurred, the vehicle control device 20 may control at least one of the engine 31, the transmission 32, and the motor 33 of the vehicle to support rapider acceleration than the normal traveling state when the driver manipulates the accelerator pedal.

In S14, the vehicle control device 20 may increase the amount of air supplied to the engine 31 so that rapid acceleration is possible when the driver manipulates the accelerator pedal in the situation in which the vehicle is overtaking. In the present case, a degree of increase in the amount of air in the engine 31 may increase as the rotation angle of the steering wheel increases.

In S14, in a case where the transmission 32 of the vehicle is a continuously variable transmission (CVT), the vehicle control device 20 may also perform control to gradually decrease the pulley ratio of the transmission 32 so that rapid acceleration is possible when the driver manipulates the accelerator pedal in the situation in which the vehicle is overtaking. In the instant case, the pulley ratio of the transmission 32 may be controlled to gradually decrease as the rotation angle of the steering wheel increases.

In S14, in a case where the vehicle is an MHEV, the vehicle control device 20 may also perform control a torque of the motor 33 so that the regenerative amount of the motor 33 decreases and the engine torque auxiliary amount of the motor 33 gradually increases. In the instant case, a degree of decrease in the regenerative amount of the motor 33 and a degree of increase in the torque auxiliary amount may be controlled to gradually increase as the rotation angle of the steering wheel increases.

The vehicle control device 20 may continuously predict whether or not the overtaking situation will end in the state in which the vehicle is overtaking (S15).

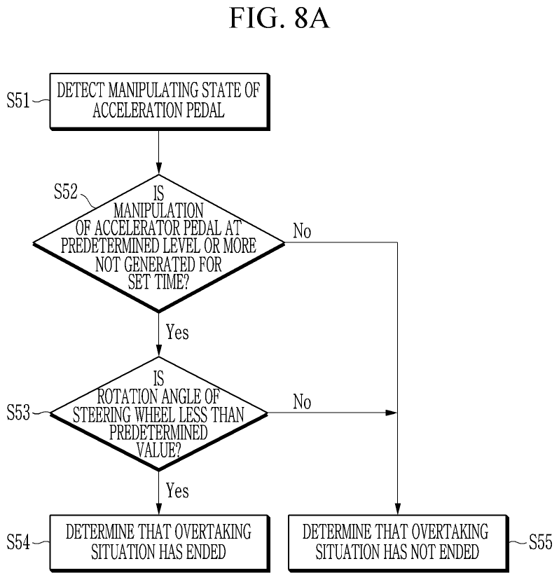

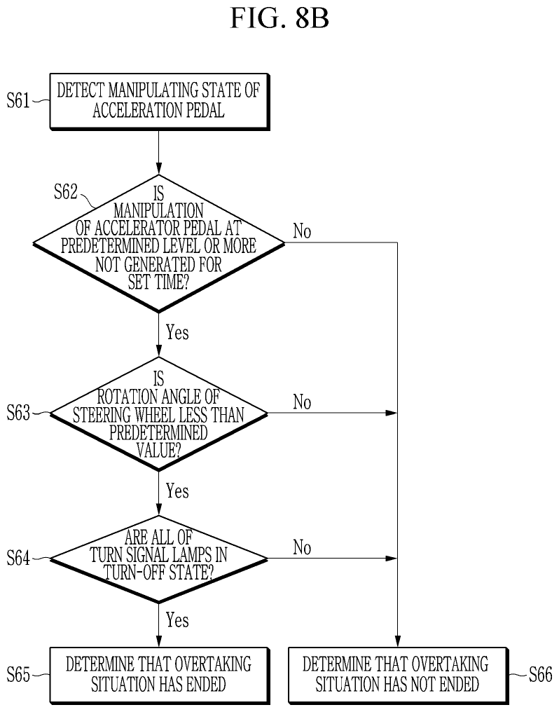

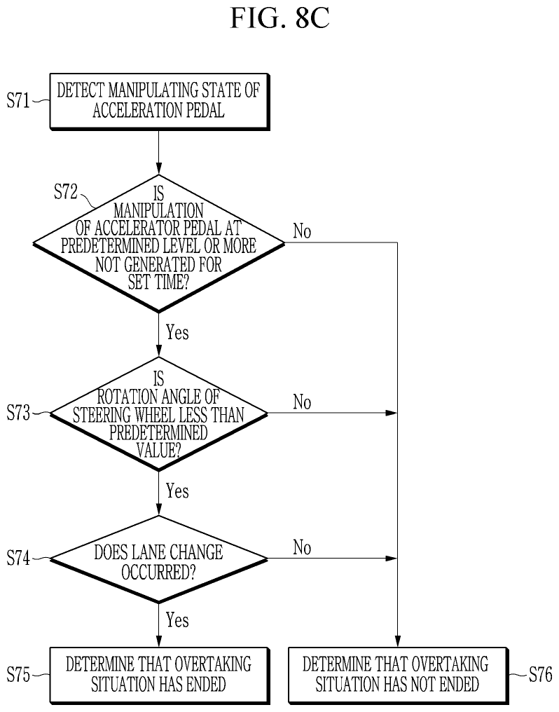

FIG. 8A, FIG. 8B and FIG. 8C schematically illustrate different exemplary embodiments of a method for predicting an end of an overtaking situation of a vehicle.

FIG. 8A schematically illustrates a method for predicting an end of an overtaking situation of the vehicle according to an exemplary embodiment of the present invention.

Referring to FIG. 8A, after it is confirmed that the overtaking situation has occurred, the vehicle control device 20 may continuously detect a manipulating state of the accelerator pedal through the accelerator pedal sensor (S51). Furthermore, in a state in which a manipulation of the accelerator pedal at a predetermined level (for example, a manipulation amount of the accelerator pedal of 3%) or more is not generated for a predetermined time period (for example, 3 seconds) or more (S52) in the situation in which the vehicle is overtaking, when the rotation angle of the steering wheel is less than the predetermined value)(20° (S53), the vehicle control device 20 may determine that the overtaking situation of the vehicle has ended (S54).

On the other hand, when the manipulation of the accelerator pedal at the predetermined level or more is generated by the driver or the rotation angle of the steering wheel is the predetermined value or more after it is confirmed that the overtaking situation has occurred, the vehicle control device 20 may determine that the overtaking situation is still being maintained (S55).

FIG. 8B schematically illustrates a method for predicting an end portion of an overtaking situation of the vehicle according to another exemplary embodiment of the present invention. The method for predicting an end of an overtaking situation of FIG. 8B may further include confirming a state of a turn signal lamp, as compared with the method for predicting an end of an overtaking situation of FIG. 8A.

Referring to FIG. 8B, in a state in which a manipulation of the accelerator pedal at a predetermined level or more than the predetermined level is not generated for a predetermined time period or more than the predetermined time period (S62) after the overtaking situation has occurred, when the rotation angle of the steering wheel is less than the predetermined value (S63), the vehicle control device 20 may additionally confirm whether or not all of the turn signal lamps are in a turn-off state in order to precisely determine an overtaking end situation (S64). Furthermore, when all of the turn signal lamps are in the turn-off state, the vehicle control device 20 may finally determine that the overtaking situation has ended (S65).

On the other hand, when the manipulation of the accelerator pedal at a predetermined level or more than the predetermined level is generated by the driver, the rotation angle of the steering wheel is the predetermined value or more, or any one of the turn signal lamps is in a turn-on state after it is confirmed that the overtaking situation has occurred, the vehicle control device 20 may determine that the overtaking situation has occurred (S66).

FIG. 8C schematically illustrates a method for predicting an end of an overtaking situation of the vehicle according to yet another exemplary embodiment of the present invention. The method for predicting an end of an overtaking situation of FIG. 8C may further include confirming whether or not a lane has been changed, as compared with the method for predicting an end of an overtaking situation of FIG. 8A.

Referring to FIG. 8C, in a state in which a manipulation of the accelerator pedal at a predetermined level or more than the predetermined level is not generated for a predetermined time period or more than the predetermined time period (S72) after the overtaking situation has occurred, when the rotation angle of the steering wheel is less than the predetermined value (S73), the vehicle control device 20 may additionally confirm whether or not a lane change of the vehicle has occurred in the overtaking situation to precisely determine an overtaking end situation (S74). Furthermore, in a case where the lane change of the vehicle has occurred in the overtaking situation, that is, in a case where the vehicle crosses at least one lane, the vehicle control device 20 may finally determine the overtaking situation has ended (S75).

On the other hand, when the manipulation of the accelerator pedal at a predetermined level or more than the predetermined level is generated by the driver, the rotation angle of the steering wheel is the predetermined value or more, or the lane change is not changed after it is confirmed that the overtaking situation has occurred, the vehicle control device 20 may determine that the overtaking situation has occurred (S76).

Referring to FIG. 6 again, when it is determined that the overtaking situation of the vehicle has ended through the methods for predicting an end of an overtaking situation described above (S16), the vehicle control device 20 may control the power train of the vehicle to gradually return to a state before the overtaking situation occurs (S17).

In S17, in a case where the amount of the intake air of the engine 31 is controlled to improve the feeling of acceleration in the overtaking situation, the vehicle control device 20 may gradually decrease the amount of the intake air of the engine 31 to return to the state before the overtaking situation occurs.

In S17, in a case where the pulley ratio of the transmission 32 is controlled to improve the feeling of acceleration in the overtaking situation, the vehicle control device 20 may gradually increase the pulley ratio of the transmission 32 to return to the state before the overtaking situation occurs.

In S17, in a case where the control of the torque of the motor 33 is performed to improve the feeling of acceleration in the overtaking situation, the vehicle control device 20 may gradually increase the regenerative amount of the motor 33 and gradually decrease the engine torque auxiliary amount of the motor 33 to return to the state before the overtaking situation occurs.

The method for controlling a power train of a vehicle according to the exemplary embodiment described above may be executed through software. When the method for controlling a power train of a vehicle is executed through software, constituent means of the present invention are code segments that perform necessary tasks. A program or code segments may be stored on a processor-readable medium or may be transmitted by a computer data signal coupled with a planet carrier wave in a transmission medium or a communication network.

Furthermore, the term related to a control device such as “controller”, “control unit”, “control device” or “control module”, etc refers to a hardware device including a memory and a processor configured to execute one or more steps interpreted as an algorithm structure. The memory stores algorithm steps, and the processor executes the algorithm steps to perform one or more processes of a method in accordance with various exemplary embodiments of the present invention. The control device according to exemplary embodiments of the present invention may be implemented through a nonvolatile memory configured to store algorithms for controlling operation of various components of a vehicle or data about software commands for executing the algorithms, and a processor configured to perform operation to be described above using the data stored in the memory. The memory and the processor may be individual chips. Alternatively, the memory and the processor may be integrated in a single chip. The processor may be implemented as one or more processors. The processor may include various logic circuits and operation circuits, may process data according to a program provided from the memory, and may generate a control signal according to the processing result.

The control device may be at least one microprocessor operated by a predetermined program which may include a series of commands for carrying out the method included in the aforementioned various exemplary embodiments of the present invention.

A computer-readable recording medium includes all types of recording devices in which data readable by a computer system is stored. Examples of the computer-readable recording medium include a read only memory (ROM), a random access memory (RAM), a compact disk-ROM (CD-ROM), a digital versatile disk-ROM (DVD ROM), a DVD_RAM, a magnetic tape, a floppy disk, a hard disk, and an optical data storage device. Furthermore, the computer-readable recording media may be distributed in computer apparatuses connected to each other through a network such that computer-readable codes may be stored and executed in the computer-readable recording media in a distributed manner.

The accompanying drawings and the detailed description have not been used to limit the meaning or limit the scope of the present invention stated in the claims, but have been used only to illustrate the present invention. Therefore, a person of an ordinary skill in the art may easily make a selection and a replacement from the accompanying drawings and the detailed description. Furthermore, a person of an ordinary skill in the art may omit some of the components described in the exemplary embodiment without degradation of performance or add components to improve performance. Furthermore, a person of an ordinary skill in the art may change the order of method steps described in the exemplary embodiment according to a process environment or equipment. Therefore, the scope of the present invention may be determined by the claims and their equivalents rather than the described exemplary embodiments.

What is claimed is:

1. An apparatus for controlling a power train of a vehicle, the apparatus comprising:
an external information detection device configured to detect information on an external environment of the vehicle;
an internal information detection device configured to detect information on a driving state of the vehicle; and
a control device configured to detect occurrence of an overtaking situation of the vehicle according to the information on the external environment and the driving state, and control the power train of the vehicle based on a rotation angle of a steering wheel of the vehicle so that a response speed to a manipulation of an accelerator pedal in the vehicle speeds up when the controller predicts that the occurrence of the overtaking situation of the vehicle is detected,
wherein the information on the external environment includes at least one of lane recognition information, a relative speed of the vehicle to a front vehicle, or inter-vehicle distance information of the vehicle to the front vehicle, and
wherein the information on the driving state includes information on at least one of a vehicle speed of the vehicle, the rotation angle of the steering wheel, a state of at least a turn signal lamp of the vehicle, and a manipulating state of the accelerator pedal of the vehicle.

2. The apparatus of claim 1,
wherein the control device is configured to predict that the overtaking situation has occurred when the control device determines that the steering wheel is rotated by a predetermined angle or more than the predetermined angle while the vehicle speed is a predetermined value or more than the predetermined value and the vehicle is approaching the front vehicle.

3. The apparatus of claim 1,
wherein the control device is configured to predict that the overtaking situation has occurred when the control device determines that the steering wheel is rotated by a predetermined angle or more than the predetermined angle and the at least a turn signal lamp of the vehicle is in a turn-on state while the vehicle speed is a predetermined value or more than the predetermined value and the vehicle is approaching the front vehicle.

4. The apparatus of claim 1,
wherein the control device is configured to predict that the overtaking situation has occurred when the control device determines that the steering wheel is rotated by a predetermined angle or more than the predetermined angle and the vehicle is approaching a lane while the vehicle speed is a predetermined value or more than the predetermined value and the vehicle is approaching the front vehicle.

5. The apparatus of claim 1,
wherein the control device is configured to predict an end of the overtaking situation according to the information on the external environment and the driving state when a manipulation of the accelerator pedal at a predetermined level or more than the predetermined level is not generated for a predetermined time period or more than the predetermined time period after the overtaking situation has occurred, and control the power train to return to a state of the power train before the occurrence of the overtaking situation when the controller determines that the overtaking situation has ended.

6. The apparatus of claim 5,
wherein the control device is configured to predict that the overtaking situation has ended when the manipulation of the accelerator pedal at the predetermined level or more than the predetermined level is not generated for the predetermined time period or more than the predetermined time period after the overtaking situation has occurred and the rotation angle of the steering wheel is less than a predetermined value.

7. The apparatus of claim 5,
wherein the control device is configured to predict that the overtaking situation has ended when the rotation angle of the steering wheel is less than a predetermined value and the at least a turn signal lamp of the vehicle is in a turn-off state while the manipulation of the accelerator pedal at the predetermined level or more than the predetermined level is not generated for the predetermined time period or more than the predetermined time period after the overtaking situation has occurred.

8. The apparatus of claim 5,
wherein the control device is configured to predict that the overtaking situation has ended in a case where the rotation angle of the steering wheel is less than a predetermined value and a lane change of the vehicle has occurred at least once after the overtaking situation has occurred while the manipulation of the accelerator pedal at the predetermined level or more than the predetermined level is not generated for the predetermined time period or more than the predetermined time period after the overtaking situation has occurred.

9. The apparatus of claim 1,
wherein the control device is configured to perform at least one of control of an amount of intake air of an engine in the vehicle, control of a pulley ratio of a transmission in the vehicle, and control of a torque of a motor in the vehicle based on the rotation angle of the steel wheel so that the response speed to the manipulation of the accelerator pedal speeds up when the control device determines that the overtaking situation has occurred.

10. The apparatus of claim 9,
wherein the control device is configured to perform control so that the amount of the intake air of the engine increases as the rotation angle of the steering wheel increases, when the control device determines that the overtaking situation has occurred.

11. The apparatus of claim 9,
wherein the control device is configured to decrease the pulley ratio as the rotation angle of the steering wheel increases, when the control device determines that the overtaking situation has occurred.

12. The apparatus of claim 11,
wherein the transmission is a continuously variable transmission (CVT).

13. The apparatus of claim 9,
wherein the control device is configured to control the torque of the motor so that a regenerative amount of the motor decreases and an engine torque auxiliary amount of the motor increases as the rotation angle of the steering wheel increases, when the control device determines that the overtaking situation has occurred.

14. The apparatus of claim 13,
wherein the vehicle is a mild hybrid electric vehicle (MHEV).

15. A method for controlling a power train of a vehicle, the method comprising:
detecting information on an external environment of the vehicle and information on a driving state of the vehicle;
detecting occurrence of an overtaking situation of the vehicle according to the information on the external environment and the driving state; and
controlling, by a control device, the power train of the vehicle based on a rotation angle of a steering wheel of the vehicle so that a response speed to a manipulation of an accelerator pedal in the vehicle speeds up when the controller predicts that the occurrence of the overtaking situation of the vehicle is detected,
wherein the information on the external environment includes at least one of lane recognition information, a relative speed of the vehicle to a front vehicle, or inter-vehicle distance information of the vehicle to the front vehicle, and
wherein the information on the driving state includes information on at least one of a vehicle speed of the vehicle, the rotation angle of the steering wheel, a state of at least a turn signal lamp of the vehicle, and a manipulating state of the accelerator pedal of the vehicle.

16. The method of claim 15,
wherein the detecting of the occurrence of the overtaking situation, includes predicting, by the control device, that the overtaking situation has occurred when the control device determines that the steering wheel is rotated by a predetermined angle or more than the predetermined angle while the vehicle speed is a predetermined value or more than the predetermined value and the vehicle is approaching the front vehicle.

17. The method of claim 15,
wherein the detecting of the occurrence of the overtaking situation, includes predicting, by the control device, that the overtaking situation has occurred when the control device determines that the steering wheel is rotated by a predetermined angle or more than the predetermined angle and the at least a turn signal lamp of the vehicle is in a turn-on state while the vehicle speed is a predetermined value or more than the predetermined value and the vehicle is approaching the front vehicle.

18. The method of claim 15,
wherein the detecting of the occurrence of the overtaking situation, includes predicting, by the control device, that the overtaking situation has occurred when the control device determines that the steering wheel is rotated by a predetermined angle or more than the predetermined angle and the vehicle is approaching a lane while the vehicle speed is a predetermined value or more than the predetermined value and the vehicle is approaching the front vehicle.

19. The method of claim 15, further including:
predicting, by the control device, an end of the overtaking situation according to the information on the external environment and the driving state when a manipulation of the accelerator pedal at a predetermined level or more than the predetermined level is not generated for a predetermined time period or more than the predetermined time period after the overtaking situation has occurred; and
controlling, by the control device, the power train to return to a state of the power train before the occurrence of the overtaking situation when the end of the overtaking situation is predicted.

20. The method of claim 19,
wherein the predicting of the end of the overtaking situation, includes determining that the overtaking situation has ended when the manipulation of the accelerator pedal at the predetermined level or more than the predetermined level is not generated for a predetermined time period or more than the predetermined time period after the overtaking situation has occurred and the rotation angle of the steering wheel is less than a predetermined value.

21. The method of claim 19,
wherein the predicting of the end of the overtaking situation, includes determining that the overtaking situation has ended when the rotation angle of the steering wheel is less than a predetermined value and the at least a turn signal lamp of the vehicle is in a turn-off state while a manipulation of the accelerator pedal at a predetermined level or more than the predetermined level is not generated for a predetermined time period or more than the predetermined time period after the overtaking situation has occurred.

22. The method of claim 19,
wherein the predicting of the end of the overtaking situation, includes determining that the overtaking situation has ended in a case where the rotation angle of the steering wheel is less than a predetermined value and a lane change of the vehicle has occurred at least once after the overtaking situation has occurred while the manipulation of the accelerator pedal at the predetermined level or more than the predetermined level is not generated for the predetermined time period or more than the predetermined time period after the overtaking situation has occurred.

23. The method of claim 15,
wherein the controlling of the power train, includes performing at least one of control of an amount of intake air of an engine in the vehicle, control of a pulley ratio of a transmission in the vehicle, and control of a torque of a motor in the vehicle based on the rotation angle of the steel wheel so that the response speed to the manipulation of the accelerator pedal speeds up when the control device determines that the overtaking situation has occurred.

24. The method of claim 23,
wherein the performing of at least one of the control of the amount of intake air of the engine, the control of the pulley ratio of the transmission, and the control of the torque of the motor, includes performing control so that the amount of the intake air of the engine increases as the rotation angle of the steering wheel increases, when the control device determines that the overtaking situation has occurred.

25. The method of claim 23,
wherein the performing of at least one of the control of the amount of intake air of the engine, the control of the pulley ratio of the transmission, and the control of the torque of the motor, includes decreasing the pulley ratio as the rotation angle of the steering wheel increases, when the control device determines that the overtaking situation has occurred.

26. The method of claim 23,
wherein the performing of at least one of the control of the amount of intake air of the engine, the control of the pulley ratio of the transmission, and the control of the torque of the motor, includes controlling the torque of the motor so that a regenerative amount of the motor decreases and an engine torque auxiliary amount of the motor increases as the rotation angle of the steering wheel increases, when the control device determines that the overtaking situation has occurred.
